(19) United States
(12) Patent Application Publication
(10) Pub. No.: US 2017/0282195 A1
(43) Pub. Date: Oct. 5, 2017

(54) CENTRIFUGAL SEPARATOR HAVING COATED SEPARATOR DISCS

(71) Applicant: SYNCRUDE CANADA LTD. in trust for the owners of the Syncrude Project as such owners exist now and, Fort McMurray (CA)

(72) Inventors: DANIEL JOHN BULBUC, Sherwood Park (CA); DAVID HAROLD CHILDS, Edmonton (CA)

(21) Appl. No.: 15/089,155

(22) Filed: Apr. 1, 2016

(51) Int. Cl. B04B 7/14; B04B 1/08; C10G 1/04

(52) U.S. Cl. CPC B04B 7/14; C10G 1/04; B04B 1/08; C10G 2300/208

(57) ABSTRACT

A method of reducing solids accumulation on a disc stack having at least one separator disc used in a centrifuge is provided, comprising: providing at least one surface of the at least one separator disc, said surface having a number of crevices therein; and coating at least a portion of the at least one surface with a coating comprising at least one fluoropolymer to fill the crevices in that portion so that the solids are prevented from settling therein.

### FIELD OF THE INVENTION

The present invention relates generally to a centrifugal separator having stacked separator discs (disc stack centrifuge). More particularly, some or all of the separator discs are coated with a surface coating useful in an abrasive environment such as an oil sands environment.

### BACKGROUND OF THE INVENTION

Oil sand deposits such as those found in the Athabasca Region of Alberta, Canada, generally comprise water-wet sand grains held together by a matrix of viscous heavy oil or bitumen. Bitumen is a complex and viscous mixture of large or heavy hydrocarbon molecules which contain a significant amount of sulfur, nitrogen and oxygen. Oil sands processing involves extraction and froth treatment to produce diluted bitumen which is further processed/upgraded to produce synthetic crude oil and other valuable commodities.

Extraction is typically conducted by mixing the oil sand in hot water and aerating the resultant slurry to promote the attachment of bitumen to air bubbles, creating a lower-density bitumen froth which floats and can be recovered in a primary separation vessel or “PSV”. Such bitumen froth is generally referred to as “primary bitumen froth”. Sand grains sink and are concentrated in the bottom of the PSV. They leave the bottom of the vessel as a wet tailings stream containing a small amount of bitumen. Middlings, a watery mixture containing fine solids and bitumen, extend between the froth and sand layers. The wet tailings and middlings are separately withdrawn, and later may be combined and sent to a secondary flotation process. This secondary flotation process is commonly carried out in a deep cone vessel, commonly referred to as a tailings oil recovery vessel or a “TOR vessel”, wherein air is sparged into the vessel to assist with flotation. The bitumen recovered by flotation in the TOR vessel is generally referred to as “secondary bitumen froth” and may be recycled to the PSV. The middlings from the deep cone vessel may be further processed in induced air flotation cells to recover contained bitumen.

Froth treatment is the process of reducing water and solids contents from the bitumen froths produced by the PSV, TOR vessel, etc. to produce a clean bitumen product (i.e., “diluted bitumen”) for downstream upgrading processes. It has been conventional to dilute this bitumen froth with a light hydrocarbon diluent, for example, with naphtha, to increase the difference in specific gravity between the bitumen and water and to reduce the bitumen viscosity, to thereby aid in the gravity separation of the water and solids from the bitumen. This diluted bitumen froth is commonly referred to as “dilfroth.” It is desirable to “clean” dilfroth, as both the water and solids pose fouling, erosion and corrosion problems in upgrading refineries. By way of example, the composition of naphtha-diluted bitumen froth typically might have a naphtha/bitumen ratio of 0.65 and contain 20% water and 7% solids. It is desirable to reduce the water and solids content to below about 3% and about 1%, respectively. Separation of the bitumen from water and solids in dilfroth may involve a sequence of various separators such as inclined plate settlers, scroll centrifuges and disc stack centrifuges.

A disc stack centrifuge separates bitumen from water and solids using extremely high centrifugal forces. When the heavy phase (i.e., water and solids) is subjected to such forces, the water and solids are forced outwards against the periphery of the rotating centrifuge bowl, while the light phase (i.e., bitumen) forms concentric inner layers within the bowl. The separator discs (i.e., the disc stack) provide additional surface settling area, which contributes to speeding up separation.

Because diluted bitumen (dilbit) comprises very abrasive solids, there is a need in the industry for centrifuge separators having discs that are wear resistant in such an abrasive environment. Furthermore, because a significant portion of the solids present in dilfroth are extremely small, e.g., less than 1 μm, the solid particles are often smaller than the voids present on conventional disc surfaces. Thus, the surfaces of conventional discs are sufficiently rough to entrap solids/clays unique to the oil sands industry and the discs get “fouled” with solids. Fouling reduces the surface area available for separation and, therefore, reduces the separation performance of the disc stack separator. Thus, there is a need in the industry for a surface coating for separator discs that improves separation performance of disc stack centrifuges by significantly reducing the solids accumulation on the discs which is also wear resistant.

### SUMMARY OF THE INVENTION

The current application is directed to a centrifuge separator having separator discs that have been surface coated with a coating to improve separation performance by reducing solids accumulation on the surface of the discs (“solids fouling”) but which is also sufficiently durable to be useful with highly abrasive feeds.

The present invention is particularly useful in the oil sands industry. The use of disc stack centrifuges with oil sands streams such as diluted bitumen (dilbit) present unique reasons for finding suitable coating for separator discs. In particular, solids accumulation is a problem, as the surface of an uncoated cold-rolled stainless steel disc is sufficiently rough to entrap fine solids/clays unique to the oil sands. Discs that have been fouled with solids lead to high machine vibrations, plugged nozzles and, therefore, downtime and lost production. Further, uncoated stainless steel discs are difficult to clean. It was discovered that coated discs stay cleaner longer and are significantly easier to clean. This improves the separation performance of the centrifuges.

It was discovered that fouled discs lead to an increase in the amount of water and solids present in the product that is normally sent directly to upgrading. However, in the present invention, use of an appropriate coating on the separator disc of the disc stack results in a 20% relative decrease in water and solids in the product.

In one aspect, a method of reducing solids accumulation on a disc stack having at least one separator disc used in a centrifuge is provided, comprising:
providing at least one surface of the at least one separator disc, said surface having a number of crevices therein; and
coating at least a portion of the at least one surface with a coating comprising at least one fluoropolymer to fill the crevices in that portion so that the solids are prevented from settling therein.

In one embodiment, the fluoropolymer is a perfluoroalkoxy alkane such as Teflon™ PFA. In one embodiment, the coating comprises a number of fluoropolymers such as polytetrafluoroethylene (PTFE), perfluoroalkoxy alkane (PFA), and fluorinated ethylene propylene (FEP). One example of a coating comprising a mixture of fluoropolymers is Xylan™ XLR.

In one embodiment, the method further comprises priming the at least a portion of the at least one surface with a primer prior to coating with the coating comprising at least one fluoropolymer. In one embodiment, the primer comprises at least one fluoropolymer.

In another aspect, a disc stack for a centrifuge is provided, the disc stack comprising:
at least one separator disc, wherein the at least one separator disc is at least partially provided with a surface coating that is capable of filling any crevices that may be present on the at least one separator disc to reduce solids fouling of the disc.

In another aspect, a centrifuge is provided, comprising:
a centrifugal drum for separating a product into phases;
a separator disc stack in the centrifugal drum, the disc stack including at least one separator disc; and
the at least one separator disc is at least partially provided with a surface coating that is capable of filling any crevices that may be present on the at least one separator disc to reduce solids fouling of the disc.

### DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a cutaway sectional view showing a disc stack centrifuge for separation of the heavy phase (water and solids) and light phase (naphtha diluted bitumen) within dilfroth.

FIG. 2 is a flowchart illustrating a naphtha diluted bitumen froth treatment process.

FIG. 3 is a scanning electron microscope image of a bottom surface of a conventional separation disc.

FIG. 4A is a schematic of the bottom surface of a separation disc and FIG. 4B is a schematic showing how solids build up on the bottom surface of a separation disc.

FIGS. 5A and 5B are photographs of a top side and a bottom side, respectively, of an untreated separation disc.

FIGS. 6A and 6B are photographs of a top side and a bottom side, respectively, of a separation disc coated according to the present invention.

### DESCRIPTION OF THE PREFERRED EMBODIMENT

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

As used herein, a “fluoropolymer coating” is a coating comprising at least one fluoropolymer. As used herein, a “fluoropolymer” is a fluorocarbon-based polymer with multiple strong carbon-fluorine bonds, e.g., a polymer including a CF₂—CH₂ moiety in the polymer chain. It is characterized by a high resistance to solvents, acids, and bases. Fluoropolymers can be homopolymers or heteropolymers. Examples of monomers useful in the preparation of fluoropolymers include ethylene (E), vinyl fluoride (fluoroethylene) (VF1), vinylidene fluoride (1,1-difluoroethylene) (VDF or VF2), tetrafluoroethylene (TFE), chlorotrifluoroethylene (CTFE), propylene (P), hexafluoropropylene (HFP), perfluoropropylvinylether (PPVE), perfluoroethers (PFE) and perfluoromethylvinylether (PMVE). Examples of useful fluoropolymers include perfluoroalkoxy alkanes or PFA, which may be copolymers of tetrafluoroethylene (C₂F₄) and perfluoroethers (C₂F₃OR^{f}, where R^{f} is a perfluorinated group such as trifluoromethyl (CF₃)), polytetrafluoroethylene (PTFE), and fluorinated ethylene propylene (FEP), a copolymer of hexafluoropropylene and tetrafluoroethylene.

As used herein, a “primer” is a composition that can further improve the adhesion of fluoropolymer coatings to substrates, in particular, metal substrates such as aluminum, steel and stainless steel. Primers typically contain a heat resistant organic binder resin and one or more fluoropolymer resins. Examples of suitable primers for adhesion of fluoropolymers are disclosed in EP 124085, WO2002/14065, U.S. Pat. No. 5,160,791, U.S. Pat. No. 5,223,343, U.S. Pat. No. 5,168,107 and U.S. Pat. No. 5,168,013.

The present invention relates generally to a centrifugal separator having stacked separator discs (disc stack centrifuge). More particularly, some or all of the separator discs are coated with a surface coating useful in an abrasive environment such as an oil sands environment. Disc stack centrifuges are routinely used in bitumen froth cleaning. In particular, bitumen froth is first diluted with a hydrocarbon diluent such as naphtha and the diluted bitumen froth is first cleaned in a series of inclined plate settlers and/or scroll centrifuges. The diluted bitumen (dilbit) thus produced is then subjected to further cleaning in disc stack centrifuges. In disc stack separators, separation of bitumen/naphtha, water, and solids occurs in the disc stack. Hydrocarbon flows towards the center of the centrifuge, while the more dense water and solids flow in the opposite direction.

The discs get fouled with solids. This reduces the area available for separation and restricts flow. It can also cause high vibrations and/or plug nozzles when the solids slough off the discs. Conventional discs are cold-rolled, polished stainless steel having a roughness ranging from about 0.4 to 0.8 μm. Generally, there are about 160 to 180 discs per stack.

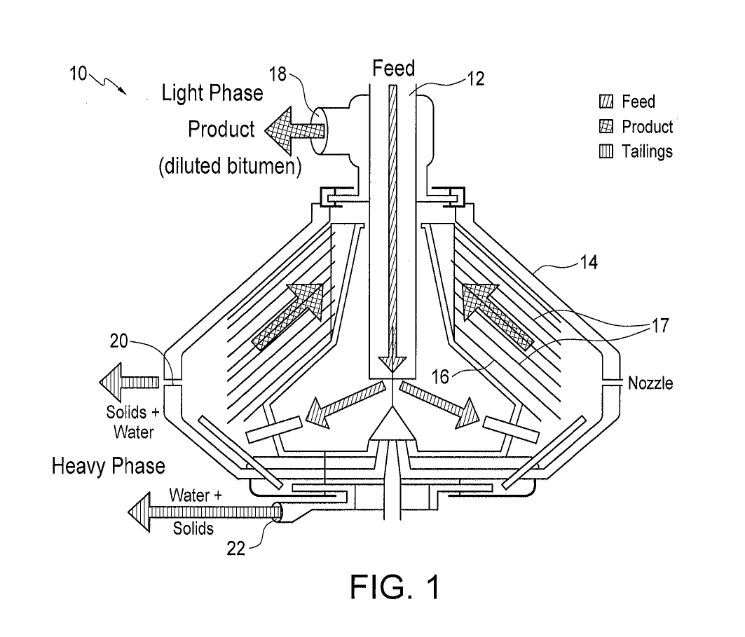

A disc stack centrifuge 10 is generally shown in FIG. 1 to include a stationary inlet pipe 12 though which the feed enters the centrifuge 10; a bowl 14 which rotates to generate centrifugal forces which separate the heavy and light phases of the feed; a disc stack 16 comprising a plurality of stacked separation discs 17 which magnifies the surface area available for separation to facilitate the separation of the heavy and light phases; a product outlet 18 at the top of the centrifuge 10 to allow the product to exit (e.g., diluted bitumen or dilbit); heavy phase discharge nozzles 20 through which the solids and some water exit the centrifuge 10; and a heavy phase discharge outlet 22 through which the water and remaining solids exits the centrifuge 10. When the bowl 14 rotates, the centrifugal forces push the solids and water outwards against the periphery of the bowl 14 to exit through the discharge nozzles 20 and discharge outlet 22. The bitumen product forms concentric inner layers within the bowl 14 to exit from the product outlet 18.

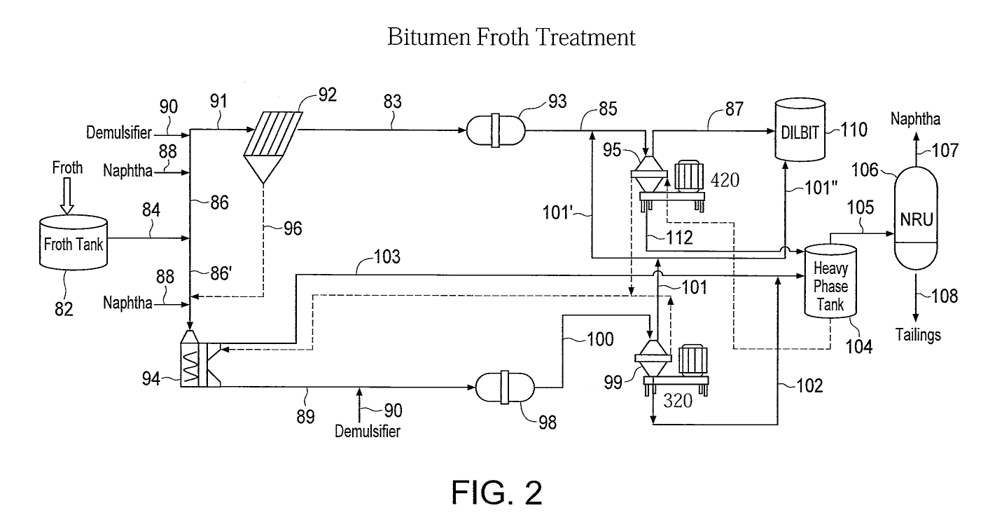

Disc stack centrifuge 10 is routinely used in a naphthenic bitumen froth treatment process as shown in FIG. 2. It is understood, however, that a disc centrifuge of the present invention can also be used in other froth treatment processes. With reference now to FIG. 2, deaerated bitumen froth 84, stored in froth tank 82, can be split into two separate streams, streams 86, 86′. Generally, bitumen froth comprises about 60 wt. % bitumen, about 30 wt. % water and about 10 wt. % solids. Naphtha 88, generally at a diluent/bitumen ratio (wt./wt.) of about 0.4-1.0, preferably, around 0.7, and a demulsifier 90 are added to bitumen froth stream 86 to form a diluted froth stream 91 (dilfroth) which is then subjected to separation in an inclined plate settler 92 (IPS). The IPS 92 acts like a scalping unit to produce an overflow 83 of diluted bitumen and an underflow 96 comprising water, solids and residual diluted bitumen.

Overflow 83 is then filtered in a filter 93 such as a Cuno™ filter to remove oversize debris still present in the diluted bitumen 83. Filtered diluted bitumen 85 is further treated in a disc centrifuge 95 which separates the diluted bitumen from the residual water (and fine clays) still present. The disc stack centrifuge separates the hydrocarbon from the water in a rotating bowl operating with continuous discharge at a very high rotational speed. Sufficient centrifugal force is generated to separate small water droplets, of particle sizes smaller than 5 μm, from the diluted bitumen.

The final diluted bitumen product 87 typically comprises between about 0.2 to 0.8 wt. % solids and 1.0-5.0 wt. % water and bitumen recovery is about 98.5% and is stored in dilbit tank 110 for further upgrading. The solids and water from centrifuge 96 are then fed to a heavy phase tank 104.

Deaerated bitumen froth stream 86′ from froth tank 82 is also treated with naphtha at a diluent/bitumen ratio (wt./wt.) of about 0.4-1.0, preferably, around 0.7. The underflow 96 from IPS 92 can be added to stream 86′ in order to recover any residual diluted bitumen present in this underflow stream. The diluted bitumen froth is then treated in a decanter (scroll) centrifuge 94 to remove coarse solids from naphtha diluted froth. Decanter centrifuges are horizontal machines characterized by a rotating bowl and an internal scroll that operates at a small differential speed relative to the bowl. Naphtha-diluted froth containing solids is introduced into the center of the machine through a feed pipe. Centrifugal action forces the higher-density solids towards the periphery of the bowl and the conveyer moves the solids to discharge ports.

The solids 103 are then fed to a heavy phase tank 104. The diluted bitumen 89 is further treated with a demulsifier 90, filtered in a filter 98 and the filtered diluted bitumen 100 is further treated in a disc stack centrifuge 99. Optionally, a portion 101′ of the resultant diluted bitumen 101 may be further treated, along with filtered diluted bitumen stream 85, in disc centrifuge 95 which separates the diluted bitumen from the residual water (and fine clays) still present to give final diluted bitumen stream 87. Generally, however, dilbit stream 101″ is sufficiently cleaned to be directly transferred to dilbit tank 110 for further upgrading. The heavy phase 102 from disc stack centrifuge 99 is also fed to heavy phase tank 104. The pooled heavy phases 105 are then treated in a naphtha recovery unit 106 where naphtha 107 is separated from the froth treatment tailings 108.

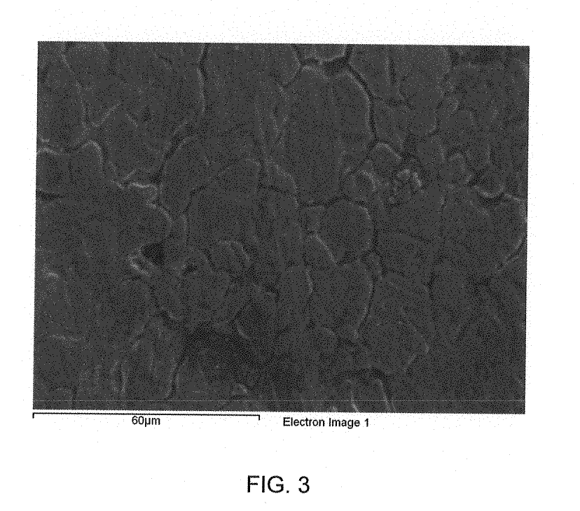

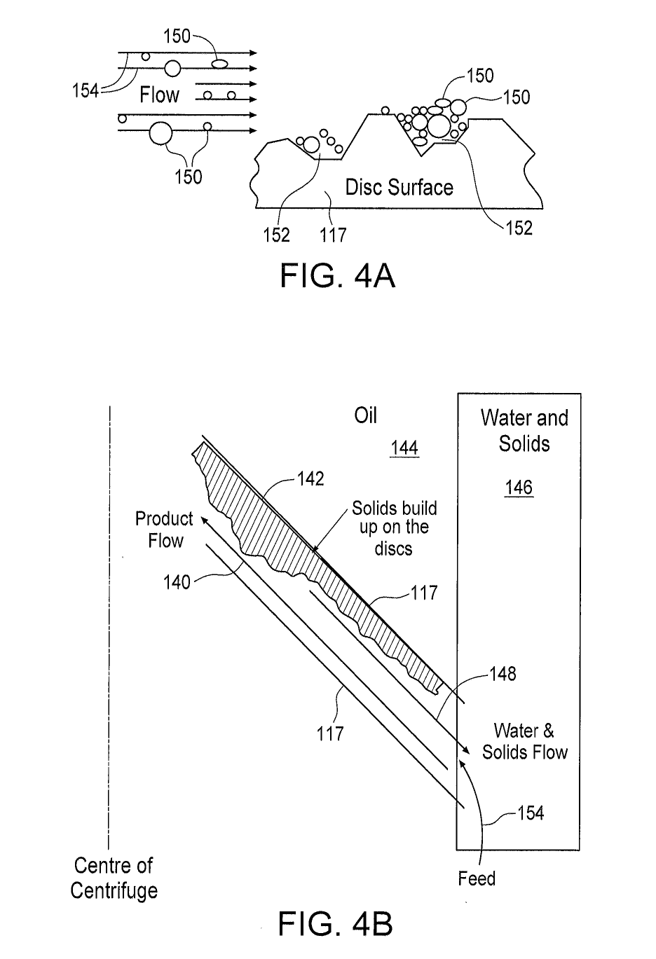

As previously mentioned, diluted bitumen contains a significant amount of fine particles having a particle size less than 1 μm, even less than 0.5 μm, and even less than 0.1 μm, which are commonly clays. These fine solids will still be present in streams 85 and 100, both of which are fed to disc stack centrifuges 95 and 99, respectively. FIG. 3 is a scanning electron microscope (SEM) image of the bottom surface of a conventional separation disc made from cold-rolled and polished stainless steel. As can be seen in FIG. 3, there are many crevices (also referred to herein as “craters” or “voids”) present on the surface of the disc which are generally less than 1 μm in size. Generally, the surface roughness is about 0.4 to about 0.8 μm. Thus, solid particles that are smaller than the crevices or voids (e.g., clays) may build up in these voids and initiate fouling. This occurrence is shown in more detail in FIGS. 4A and 4B.

FIG. 4A is a schematic of the bottom surface of disc 117 showing craters 152. As the feed 154, such as diluted bitumen, flows across the disc surface, as shown on left hand side, particles 150 smaller than the crater size may get deposited in these craters 152 and initiate plugging. After a period of time, solids will build up on the discs, which will reduce the area available for separation and restrict flow. Further, it may cause high vibrations and plug the nozzles when the solids slough off the disc. FIG. 4B is a schematic showing how solids may build up on separation discs. In particular, FIG. 4B is a schematic showing the separation of bitumen (oil), water and solids from feed 154, e.g., diluted bitumen. Feed 154 is directed between discs 117 where the hydrocarbon product 140 flows towards the center of the centrifuge (oil 144) while the more dense water and solids 148 flow towards the opposite direction (water and solids 146). Because of the crevices (craters), as shown in FIG. 3, solids will begin to build upon the surfaces of discs 117 and form a solids layer 142. This reduces the area available for separation and restricts flow. It also causes high vibrations and plugs nozzles when the solids layer 142 sloughs off the discs.

Thus, it was observed in naphtha-based froth treatment that when conventional disc stacks foul with solids, less surface area resulted in poor product (i.e., dilbit) quality. The high vibrations increased risk of failure and nozzle plugging from the solids that slough off the disc surface further contributed to the high vibrations. Thus, solids fouled discs lead to increased downtimes and lost production. Finally, the conventional discs were much harder to clean due to the entrapment of the solids/clays that are unique to oil sands.

Hence, the present invention is directed to decreasing the surface roughness of separation discs via particular coatings which are useful in reducing the initial build-up of solids on the surface of the discs. Preventing or minimizing downtimes by reducing disc stack solids fouling would provide additional plant capacity. A 4% increase in availability of current disc centrifuges at the applicant's froth treatment plant is approximately equivalent to one extra disc stack centrifuge. Further, less solids fouling increases the product quality (less water & solids in the product) by providing more separation surface area over time, i.e., the disc stacks have more clean area for longer periods of time.

Several options for surface finish were field tested for use in a naphtha-based bitumen froth treatment facility. The following examples describe the coatings which successfully met the criteria for durability, lowered solids fouling and ease of cleaning.

### Example 1

Individual discs in a disc stack were coated with Whitford Xylan™ XLR. Xylan™ XLR is a fluoropolymer nonstick coating that has been developed specifically to provide dry-film release with exceptional resistance to permeation. The heat-resistant coating offers greatly increased release-life as well as a reduced tendency for formed parts to stick to the mold, for food to stick to industrial bakeware, for polyethylene to stick to heat-sealing bars or other difficult applications where release is required. Fluoropolymers utilized in Xylan™ coatings include PTFE, PFA, and FEP.

In one embodiment, the discs were first primed with Xylan™ XLR 17-080/D9915 Black Primer and then finished with Xylan™ XLR 17-353/D9172 Topcoat Emerald Green. This two-coat, waterborne system consists of a unique, super-high release topcoat with a lightly reinforced primer suitable for a variety of substrates including carbon steel. A more heavily reinforced primer is available for applications where a lot of abrasion resistance is required. It is food-safe and can be used at temperatures up to 500° F./260° C.

In one embodiment, Xylan™ XLR is applied in a three step process. First, the metallic surfaces of the discs are surface prepared (e.g., by grit or sand blasting and the like) to provide a surface roughness of about 100 to about 200 micro-inches (Ra). The Xylan™ XLR 17-080/D9915 Black Primer is then applied on the roughened metal surfaces with a thickness of about 5 to about 12.5 μm. The top coat, Xylan™ XLR 17-353/D9172 Topcoat Emerald Green, is then applied over the primer to a thickness of about 15 to about 30 μm. The top coat (or coating) is generally available in either a powder or a liquid and can be sprayed by spray equipment known in the art. Powder coatings are generally applied with conventional electrostatic powder equipment, with either spray guns or fluidized beds. The discs are then cured at the proper cure temperature for a sufficient period of time to set the coating, which temperature and time will vary according to the particular fluoropolymer composition.

In some instances, the discs may need to be further prepared prior to applying the primer and coating. For example, if the discs already have an existing coating, the existing coating can be thermally removed. Further, the discs can be heat treated to remove any organics which may be present on the surface.

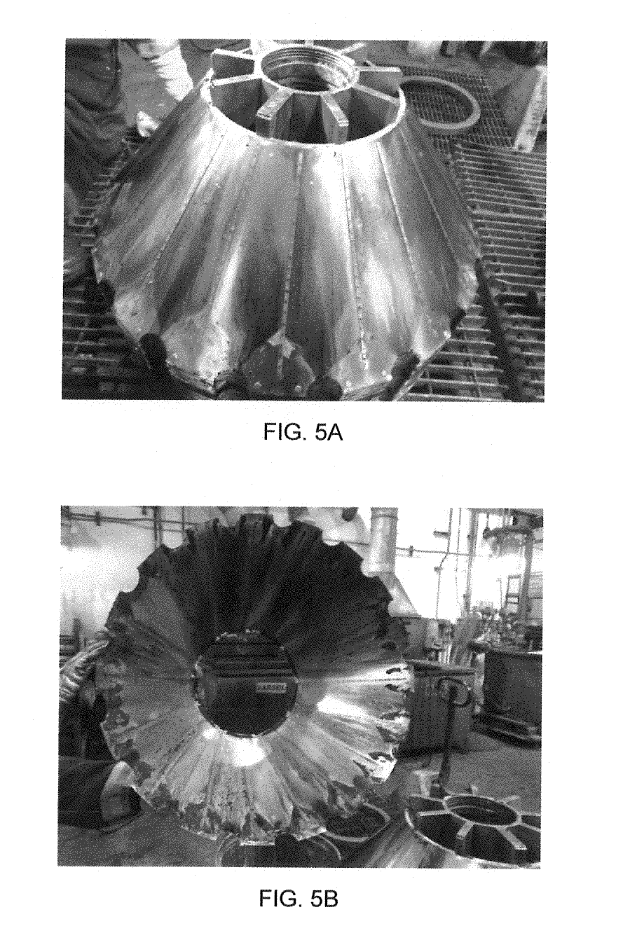

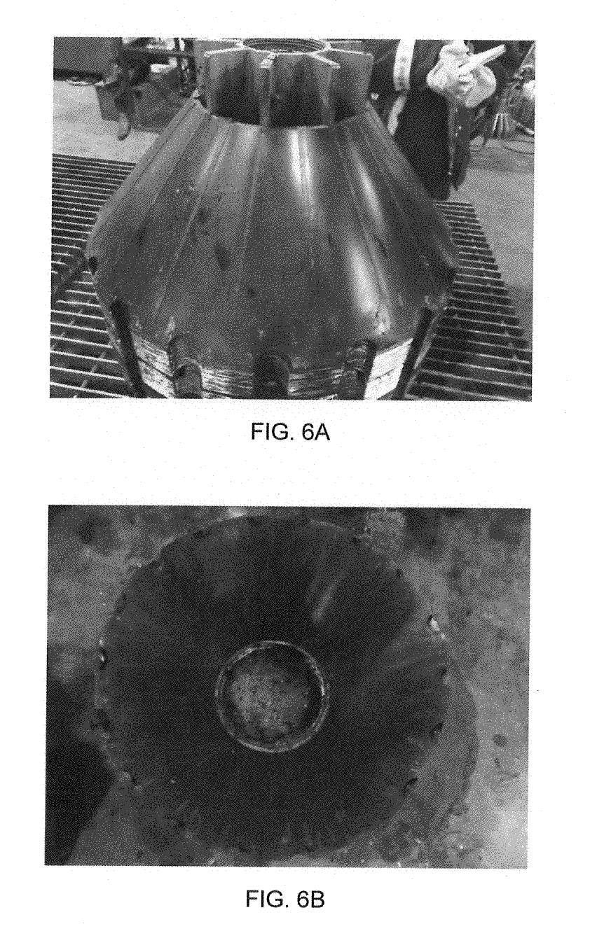

FIGS. 5A and 5B are photographs of a top side and bottom side, respectively, of a stainless steel disc stack that has not been coated as per the present invention. It can be seen that both the side and bottom of the disc stack has been substantially fouled by adherence of solids. FIGS. 6A and 6B are photographs showing a top side and bottom side, respectively, of a disc stack that has been coated with Xylan™ XLR. It can be seen that when the discs of a disc stack were coated with Xylan™ XLR, very little solids fouling could be seen. Hence, Xylan™ XLR discs have significantly less fouling than stainless steel discs. Furthermore, it is expected that Xylan™ XLR coating will last longer than two years in service.

### Example 2

In this example, individual discs in a disc stack were coated with Teflon™ PFA. Teflon™ PFA (perfluoroalkoxy copolymer) is a nonstick fluoropolymer coating which melts and flows during baking to provide nonporous films. Teflon™ PFA coatings offer the additional benefits of higher continuous use temperature (260° C./500° F.), greater toughness than Teflon™ PTFE or Teflon™ FEP, and some Teflon™ PFA coatings can have film thicknesses of up to 1,000 micrometers (40 mils). This combination of properties makes Teflon™ PFA an excellent choice for a wide variety of uses, especially those involving chemical resistance. Teflon™ PFA protective coatings are available in both water-based liquid and powder forms.

In one embodiment, the discs were first primed with Teflon™ 420G-703 Black Primer and then finished with Teflon™ 858G-210—PFA High Build Liquid Topcoat-Clear. Teflon™ primers are an effective way to prepare a surface before the coating is applied. Primers ensure proper adhesion, increase durability, and give additional protection to the substrate. With the use of primers, the coating is given a smooth surface to bind to, which creates a more protective layer. This additional layer decreases porosity of the coating to the substrate.

From the foregoing description, one skilled in the art can easily ascertain the essential characteristics of this invention. However, the scope of the claims should not be limited by the preferred embodiments set forth in the examples, but should be given the broadest interpretation consistent with the description as a whole.

What is claimed:

1. A method of reducing solids accumulation on a disc stack having at least one separator disc used in a centrifuge, comprising:
providing at least one surface of the at least one separator disc, said surface having a number of crevices therein; and
coating at least a portion of the at least one surface with a coating comprising at least one fluoropolymer to fill the crevices in that portion so that the solids are prevented from settling therein.

2. The method as claimed in claim 1, wherein the at least one fluoropolymer is selected from the group consisting of perfluoroalkoxy alkanes (PFA), polytetrafluoroethylene (PTFE), and fluorinated ethylene propylene (FEP).

3. The method as claimed in claim 1, wherein the coating comprises a mixture of perfluoroalkoxy alkanes (PFA), polytetrafluoroethylene (PTFE), and fluorinated ethylene propylene (FEP).

4. The method as claimed in claim 1, wherein the at least one fluoropolymer is perfluoroalkoxy alkanes (PFA).

5. The method as claimed in, claim 1, wherein the at least one separator disc is surface prepared by grit or sand blasting to provide a surface roughness of about 100 to about 200 micro-inches (Ra) prior to coating.

6. The method as claimed in claim 1, wherein the at least one separator disc is surface prepared to remove organics prior to coating.

7. The method as claimed in claim 1, the method further comprising:
priming the at least a portion of the at least one surface with a primer prior to coating with the coating comprising a fluoropolymer.

8. The method as claimed in claim 7, wherein the primer comprises at least one fluoropolymer.

9. The method as claimed in claim 7, wherein the primer has a thickness of about 5 to about 12.5 μm.

10. The method as claimed in claim 9, wherein the coating has a thickness of about 15 to about 30 μm.

11. A disc stack for a centrifuge, comprising:
at least one separator disc, wherein the at least one separator disc is at least partially provided with a surface coating that is capable of filling any crevices that may be present on the at least one separator disc to reduce solids fouling of the disc.

12. The disc stack as claimed in claim 11, wherein the surface coating comprises at least one fluoropolymer.

13. The disc stack as claimed in claim 11, wherein the surface coating comprises perfluoroalkoxy alkanes (PFA), polytetrafluoroethylene (PTFE), fluorinated ethylene propylene (FEP), or combinations thereof.

14. A centrifuge, comprising:
a centrifugal drum for separating a product into phases;
a separator disc stack in the centrifugal drum, the disc stack including at least one separator disc; and
the at least one separator disc is at least partially provided with a surface coating that is capable of filling any crevices that may be present on the at least one separator disc to reduce solids fouling of the disc.

15. The centrifuge as claimed in claim 14, wherein the surface coating comprises at least one fluoropolymer.

16. The centrifuge as claimed in claim 14, wherein the surface coating comprises perfluoroalkoxy alkanes (PFA), polytetrafluoroethylene (PTFE), fluorinated ethylene propylene (FEP), or combinations thereof.
